(19) United States
(12) Patent Application Publication
(10) Pub. No.: US 2021/0073655 A1
(43) Pub. Date: Mar. 11, 2021

(54) RULE MINING FOR RULE AND LOGIC STATEMENT DEVELOPMENT

(71) Applicant: SAP SE, Walldorf (DE)

(72) Inventors: Jan Portisch, Bruchsal (DE); Ronald Boehle, Dielheim (DE); Volker Saggau, Bensheim (DE); Sandra Bracholdt, Dielheim (DE)

(73) Assignee: SAP SE, Walldorf (DE)

(21) Appl. No.: 16/567,470

(22) Filed: Sep. 11, 2019

(51) Int. Cl. G06N 5/02; G06F 16/901

(52) U.S. Cl. CPC G06N 5/025; G06F 17/18; G06F 16/9027

(57) ABSTRACT

Smart rule development and rule mining functionality is provided herein. Rule mining for use in rule development can include generating logic statement proposals, rule deduplication, and rule template generation. Rule mining can include accessing a rule set to analyze the rule set against an input logic statement to identify existing rules which match at least in part the input logic statement. Rule deduplication can include returning exact rule matches to replace the input logic statement. Proposing logic statements can include returning logically related rules from rules found that include the input logic statement. Generating rule templates can include returning a template based on the entire rule(s) which includes the input logic statement. Ranking scores can be calculated for returned rules, whether for deduplication, proposals, or template generation. The scores can be based on statistical information for the rules, such as usage of the rule or coverage of the rule.

### BACKGROUND

The amount of data in database and enterprise systems continues to increase at a high pace. In practice, such data is often stored in data silos that prevent full utilization. The different data silos may be matched together, identifying equivalent data or schemas between the data silos, which may allow greater integration or use of the data. However, matching data silo schemas or data silo data often requires the cumbersome, manual process of rule building by domain experts or consultants, so it is very labor-intensive and costly. Thus, there is room for improvement.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method, which can be implemented by one or more computing devices including at least one hardware processor and one or more tangible memories coupled to the at least one hardware processor, of rule mining is provided herein. The method can include receiving an input logic statement tree. The method can include selecting a stored logic statement tree from a logic statement repository. The input logic statement tree matches at least a portion of the stored logic statement tree. The method can include identifying one or more logic statement subtrees within the stored logic statement tree. The one or more logic statement subtrees can be logically related to the portion of the stored logic statement tree that matches the input logic statement. The method can include providing the one or more logic statement subtrees. The respective one or more logic statement subtrees can represent complete logic statements.

A method of rule mining, which can be implemented by one or more non-transitory computer-readable storage media storing computer-executable instructions for causing a computing system to perform the method, is provided herein. The method can include receiving an input logic statement tree. The method can include identifying a stored logic statement tree from the logic statement repository. The stored logic statement tree can be logically equivalent to the input logic statement tree. The method can include replacing the input logic statement tree with a reference to the identified stored logic statement tree.

A system which can perform a method of rule mining is provided herein. The method can include receiving at least a portion of an initial logic statement tree. The method can include identifying one or more stored logic statement trees from a logic statement repository. The stored logic statement trees can match the at least a portion of the initial logic statement tree. The method can include providing the identified one or more stored logic statement trees. The method can include receiving a selection of a logic statement tree of the one or more identified logic statement trees. The method can include generating a logic statement template based on the selected logic statement tree. The logic statement template can include one or more subtrees. The method can include providing the generated logic statement template.

The foregoing and other objects, features, and advantages of the invention will become more apparent from the following detailed description, which proceeds with reference to the accompanying figures.

### BRIEF DESCRIPTION OF THE DRAWINGS

FIG. 1A is a block diagram of an example system implementing automated rule development and rule mining.

FIG. 1B is an architecture diagram depicting a rule miner and a multitenant database arrangement.

FIGS. 2A-E are an example illustrating how a rule can be represented as a binary tree for use in rule mining.

FIG. 3 is a flowchart of an example method of mining a rule set to generate one or more logic statement proposals.

FIG. 4 is a flowchart of an example method of mining a rule set to deduplicate an input rule.

FIG. 5 is a flowchart of an example method of mining a rule set to provide a rule template.

FIGS. 6A-C are an example illustrating how a rule set can be mined to generate rule mining results based on a rule development request.

FIGS. 7A-D are an example illustrating a rule development workflow in a user interface for rule development utilizing rule mining functionality.

FIG. 8A is an exemplary application environment for a rule mining module.

FIG. 8B is an exemplary system environment for a rule mining module.

FIG. 8C is an exemplary network environment for a rule mining module.

FIG. 9 is a diagram of an example computing system in which described embodiments can be implemented.

FIG. 10 is an example cloud computing environment that can be used in conjunction with the technologies described herein.

### DETAILED DESCRIPTION

### EXAMPLE 1

### Overview

The ever-increasing amount of incoming data and transformation of the enterprise into a data-driven world creates many difficulties as data is indeed accumulated, but not always in an organized or arranged manner. Often, data is split into different operational and analytical systems, and stored in data silos, which can prevent effective use of the full potential of the data. Essentially data segregation into data silos leads to semantic and technological heterogeneity, resulting in analytical barriers. Overcoming the heterogeneity between data silos may be accomplished by finding an alignment between the disparate data schemas and defining rules which can specify how the data is translated between the disparate schemas, such as by the process of schema matching or aligning, and data integration.

Data integration can include schema matching and data translation. Generally, schema matching includes identifying which fields or other data structures between two schemas represent the same or equivalent semantic content. Data translation generally specifies how the data in these fields or structures is translated (e.g. moved, written, transformed, or the like) between the two schemas. For example, schema1.field1 and schema1.field2 may be mapped to schema2.field3, (schema1.field1, schema1.field2)→schema2.field3. The data translation may be defined by a rule or logic statement such as: IF(schema1.field1>1000 AND schema1.field1<10000 AND schema1.field2>100) THEN schema2.field3=“BASIC”.

Within this schema matching and data integration process, rules can be created that describe how the data is transformed from one schema into the other. Similarly, such rules may also be developed for triggering system or software functionality, or directing a process flow or work flow in a computing system.

Generally, rule development is a manual process, with little to no technical support and lacking intelligent functionality such as smart auto-complete, generating rule proposals, deduplication, or smart template generation.

There are many scenarios where generating rules for mapping data transformations or directing process flows can be helpful. As a first example, an entity can obtain a new data model and have specialists map data into the new data model. The specialists may work on separate parts of the data models independently, and so may develop rules which overlap and identify the same data. Because the specialists may not be aware of each others' activity and which rules, in particular, they develop, duplicate rules or duplicate parts/portions of rules (e.g. subrules) may be created. This both is extraneous work on the part of the specialists unknowingly developing the duplicate rules, and can negatively impact performance and maintenance of the data mapping using the rules.

As a second example continuing the first, a specialist can complete extensive work developing rules for a first area, and then begin developing rules in a related area. Because the areas are related, some of the rules or portions of the rules could be reused. The specialist can begin to reanalyze the already created rules, but this can take extensive time and effort, even for a specialist that originally created the rules (which may have been done weeks or months before). In some cases, the rules the specialist may build for the second area can end up being very similar to the rules previously built for the first area. Thus, the rules developed for the second area can be duplicative or extraneous, which slows development and creates complexity in the rule set.

As a third example, a manager overseeing a data mapping or data integration project may learn that exploiting or reusing existing knowledge is an effective way to improve quality and speed project completion. The manager may wonder how to incorporate the use of existing knowledge in his slow data mapping project.

As a fourth example, rules can be used to complete legal forms or legal templates, which can have specific deadlines for compliance. A change to the legal requirements (e.g. the legal forms or templates) can require changes to the rule set. However, the rule set can be very complex and duplicative, which can make implementing the change based on the change in the law very difficult and time-consuming, or even prone to error. This can impact meeting deadlines for providing correct completed forms or templates. Further, the existence of duplicated rules can make identifying all the rules that must be changed difficult or nearly impossible. This can not only increase the time to adapt the rules to the change, but can cause an increase in cost (which may not be budgeted for).

Smart rule development and rule mining functionality as described herein can generally alleviate these issues, in some cases removing them entirely, and generally improves system performance and result accuracy. Rule mining for rule development can include rule deduplication in a rule set, identifying and providing logic statement or rule proposals, and generating rule templates. Such rule mining functionality can assist rule development, improving the process of rule development and the quality of rules developed.

For example, rule deduplication can save time and thus improve development efficiency. With smart rule deduplication, a user developing a rule does not need to lookup already created rules manually. Further, rule deduplication can lead to easier to understand rules, by reusing rules with informative or meaningful labels or other metadata. Such easier to understand rules can also speed rule development, without requiring a user to spend excess time analyzing a complex logic statement to understand it. Rule deduplication can also reduce complexity of a rule set, reducing the number of rules stored (and so reducing the memory footprint of the rule set) and reducing the number of rules a user may need to be familiar with. Rule maintenance and change management can also be improved by rule deduplication, by limiting the number of rules that need to be changed to correct or change rule functionality. Moreover, rule usage or other statistics are improved by rule deduplication, and can generally provide a more accurate representation of rule usage by not having logically equivalent rules treated as separate rules, and so splitting statistically information for the functionality represented by the rule.

For example, rule proposals can save time as a user does not need to recreate a rule but can choose from a set of options of rules already available (e.g. reuse a rule), which can speed rule development (especially for complex rules). Rule proposals can also include metadata about the rules, which can make the rules easier to understand with meaningful or informative labels or other metadata for the rules. This can improve quality of rule development as well as rule development efficiency. Further, such rule proposals can be from similar contexts, which can be indicated by scores, and so can be more likely to be useful or applicable to the rule being developed. Proposing existing rules also leads to increased rule deduplication by reusing rules within other rules.

For example, rule templates can also provide similar advantages as rule deduplication and rule proposals. Generally, use of a rule template can increase speed and efficiency of rule development by allowing a user to make small changes to an existing rule rather than completely redevelop a complex rule from the start. Rule templates can also reduce complexity of a rule set by deduplicating rules within the rule template by referencing existing rules within the template.

The automatic rule development and rule mining functionality, as described herein, can be integrated with other rule writing or rule persistence technology. Rule writing functionality can include the rule language technologies disclosed in U.S. patent application Ser. No. 16/265,063, titled “LOGICAL, RECURSIVE DEFINITION OF DATA TRANSFORMATIONS,” filed Feb. 1, 2019, having inventors Sandra Bracholdt, Joachim Gross, and Jan Portisch, and incorporated herein by reference, which can be used as a rule-writing system or language for generation, development, storage, or maintenance of logic statements or rules as described herein. Further, rules for mapping or data transformations, such as between data models or schemas, can utilize the metastructure schema technologies disclosed in U.S. patent application Ser. No. 16/399,533, titled “MATCHING METASTRUCTURE FOR DATA MODELING,” filed Apr. 30, 2019, having inventors Sandra Bracholdt, Joachim Gross, Volker Saggau, and Jan Portisch, and incorporated herein by reference, which can be used as data model representations for analysis, storage, development, or maintenance of logic statements or rules as described herein.

Automatic rule development and rule mining functionality can be provided in data modelling software, integrated development environments (IDEs), data management software, data integration software, ERP software, or other rule-generation or rule-persistence software systems. Examples of such tools are: SAP FSDP™ technology, SAP FSDM™ technology, SAP PowerDesigner™ technology, SAP Enterprise Architect™ technology, SAP HANA Rules Framework™ technology, HANA Native Data Warehouse™ technology, all by SAP SE of Walldorf, Germany.

### EXAMPLE 2

### Example System that Mines Rule Sets for use in Rule Development

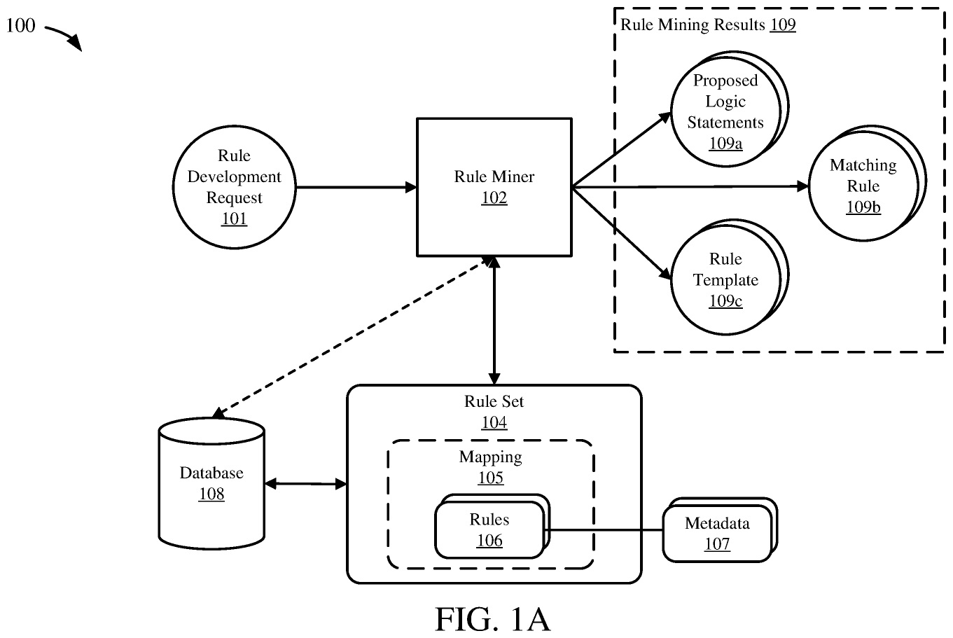

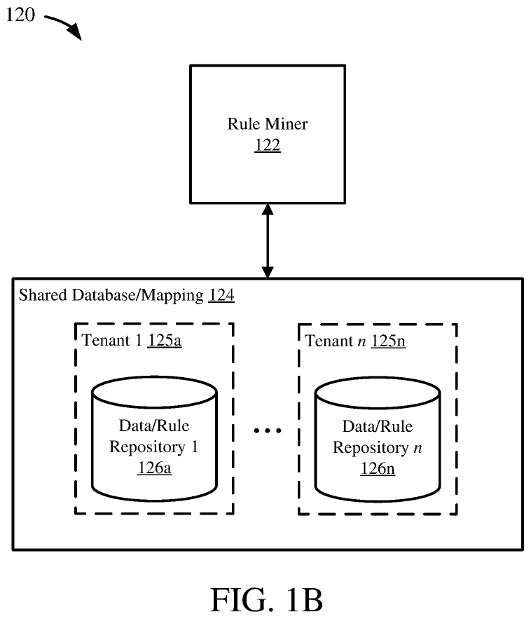

FIG. 1A is a block diagram of an example system 100 implementing automated rule development and rule mining. A rule miner 102 can automatically generate one or more types of rule mining results 109, such as logic statement proposals 109a, matching rules for rule deduplication 109b, or rule templates 109c. The rule miner 102 can provide rule mining functionality directly, or it may be integrated in an application, such as an integrated development environment (IDE) or with a user interface.

The rule miner 102 can receive a rule development request 101. The request 101 can be a function call or can be made through an API or other interface of the rule miner 102. In some embodiments, the request 101 can be a trigger which initiates functionality in the rule miner 102, such as based on an input or a context change.

The rule development request 101 can include one or more variables for generating the requested rule mining results 109. For example, the request 101 can include an indicator for the type(s) of rule mining result 109a-c. The request 101 can further include a rule, which can be used in rule mining, such as to identify one or more matching rules 109b, as described herein. In some embodiments, the rule can be provided directly as part of the rule development request 101. In other embodiments, identifiers or memory locations can be provided for the rule in the request 101. In some embodiments, such as when the request 101 is a trigger, the rule can be available for the rule miner 102 as part of the system 100 context, rather than being provided as part of the request 101. For example, in an IDE, the rule miner 102 can be activated by a user entering a rule, which can trigger the rule miner to begin automatically generating one or more rule mining results for the rule based on the rule and/or other information in the current context of the IDE, such as a mapping or other existing rules in the IDE.

The rule development request 101 can also identify a rule set, such as rule set 104 or mapping 105, to mine. In some embodiments, the request 101 can include the rule set 104 or mapping 105 itself, or an identifier or memory location for the rule set or mapping. In other embodiments, the request 101 can include an identifier for a data source, such as a database 108, from which a rule set 104 or mapping 105 can be obtained or accessed. In some cases, the rule set 104 or mapping 105 can be identified based on the context of the rule miner 102.

The rule development request 101 can also include one or more configurable configuration settings or options, such as a value indicating a preferred number of generated rule templates or logic statement proposals, or a threshold score for generated logic statement proposals.

The rule miner 102 can access a rule set 104 for generating rule mining results 109 as described herein. The rule set 104 can be obtained from a database 108, such as based on the rule development request 101. The rule set 104 can include one or more existing rules 106. The rules 106 can be grouped together in a mapping 105, or be available across multiple mappings. In some cases, the mapping 105 can be co-extensive with the rule set 104. In other cases, the rule set 104 can include rules from different mappings, or rules not in a mapping.

The rule miner 102 can analyze the rule set 104 to determine one or more rule mining results 109. The rule mining results 109 can include one or more proposed logic statements 109a, one or more matching rules 109b, or one or more rule templates 109c, or a combination thereof. The rule miner 102 can access the rule set 104 to mine the available rules 106 to generate one or more proposed logic statements 109a based on the rule development request 101. Additionally or alternatively, the rule miner 102 can access the rule set 104 to mine the available rules 106 to identify one or more matching rules 109b to a rule provided in the rule development request 101. Additionally or alternatively, the rule miner 102 can access the rule set 104 to mine the available rules 106 to generate one or more rule templates based on the rule development request 101.

The rules 106 can include metadata 107, which can further describe or provide additional data regarding their respective rules. Generally, a given rule 106 can have an associated set of metadata 107. The metadata 107 can be accessed by the rule miner 102, in addition to the rules 106, and used in generating rule mining results 109. For example, the metadata 107, or some portion of the metadata (e.g. fields), can be provided as part of the rule mining results 109.

In practice, the systems shown herein, such as system 100, can vary in complexity, with additional functionality, more complex components, and the like. For example, there can be additional functionality within the rule miner 102. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the instructions for implementing the rule miner 102, the input, output and intermediate data of running the rule miner 102, or the database 108, and the like can be stored in one or more computer-readable storage media or computer-readable storage devices. The technologies described herein can be generic to the specifics of operating systems or hardware and can be applied in any variety of environments to take advantage of the described features.

### EXAMPLE 3

### Example Rule Miner with a Multitenant Rule Repository

FIG. 1B is an architecture diagram depicting a rule miner and a multitenant database arrangement 120. A rule miner 122 can mine rules and rule data from a shared database or data model mapping 124, similar to FIG. 1A. The shared database or data model mapping 124 can reside on a network (e.g. in the cloud) and can have one or more tenants, such as Tenants 1-n 125a-n, which access or otherwise use the shared database/mapping.

The tenants 125a-n can have their own respective sets of rules or rule data in the database 124, such as Data/Rule Repository 1 126a for Tenant 1 125a through Data/Rule Repository n 126n for Tenant n 125n. The rule repositories 126a-n can include rules or rule data based on the database/data model, such as within a mapping for transforming a database/data model. The rule repositories 126a-n can reside outside tenant portions of the shared database 124 (e.g. secured data portions maintained separate from other tenants), so as to allow access to the rules or rule data by the rule miner 122 without allowing access to sensitive or confidential tenant information or data. The rule repositories 126a-n can have any sensitive or confidential information masked or removed, or may have all data removed and only contain rules or partial rules (e.g. logic statements).

The rule miner 122 can access some or all of the rule repositories 126a-n when mining the shared database 124. In this way, the broad knowledge developed across multiple tenants, and database developers, specialists, or administrators of those tenants, can be accessed and used through rule mining, as described herein, to auto-generate or recommend rule statements, including portions of rule statements, rule templates, or deduplicate rules (e.g. reuse rules).

### EXAMPLE 4

### Example Rule Trees

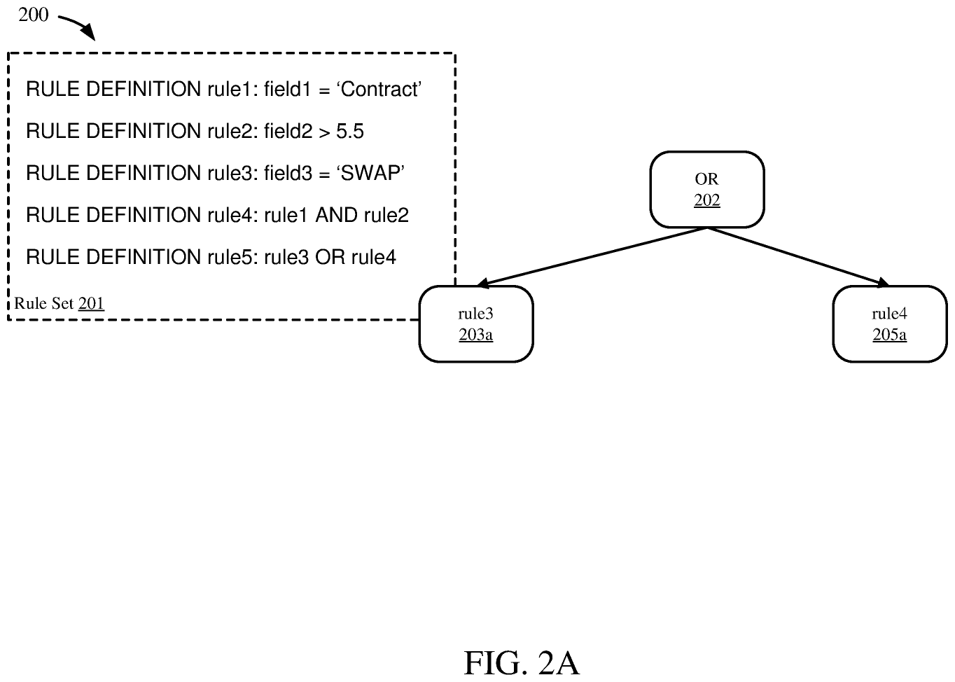

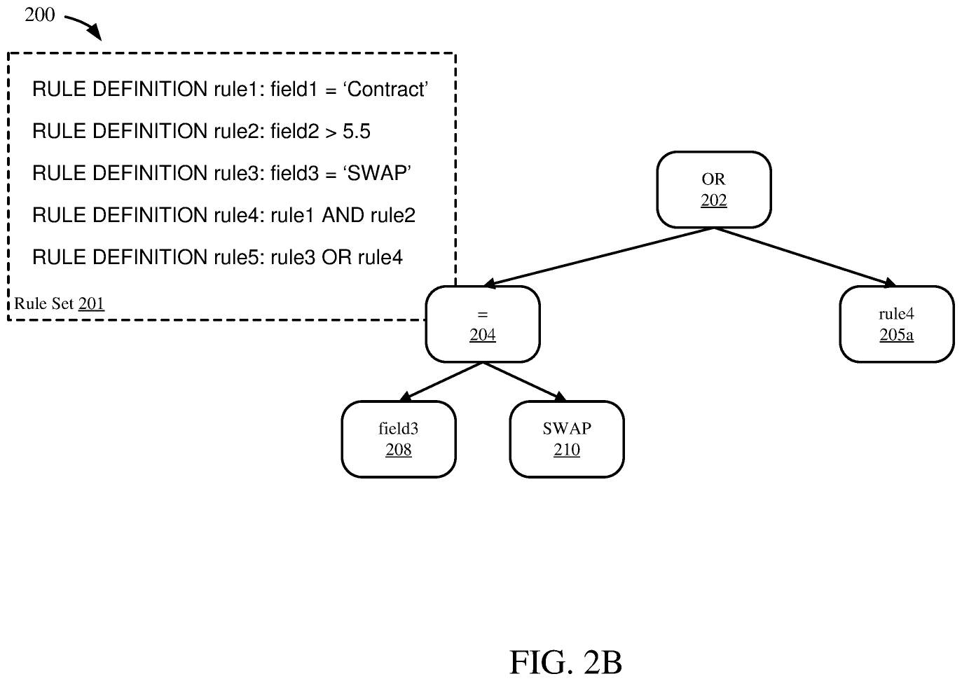

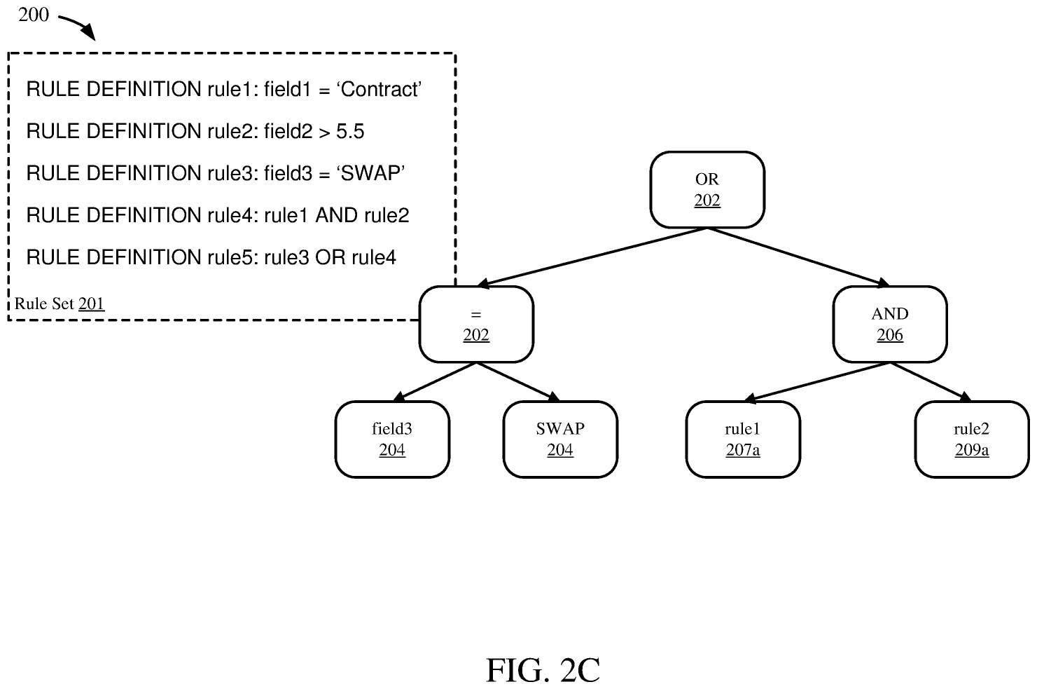

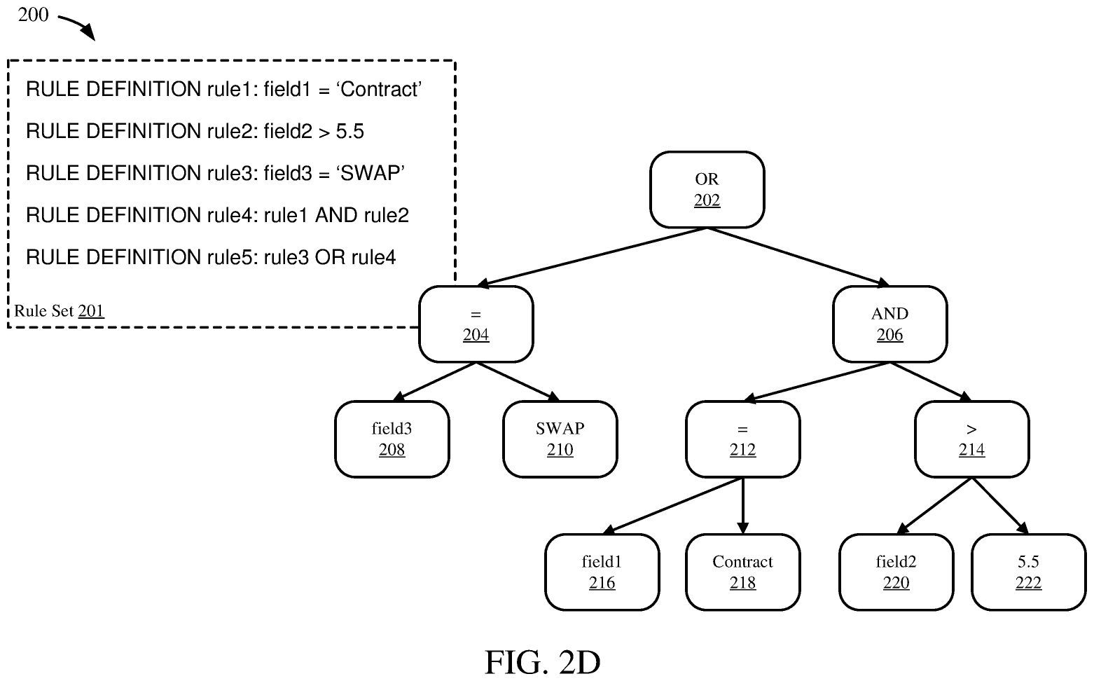

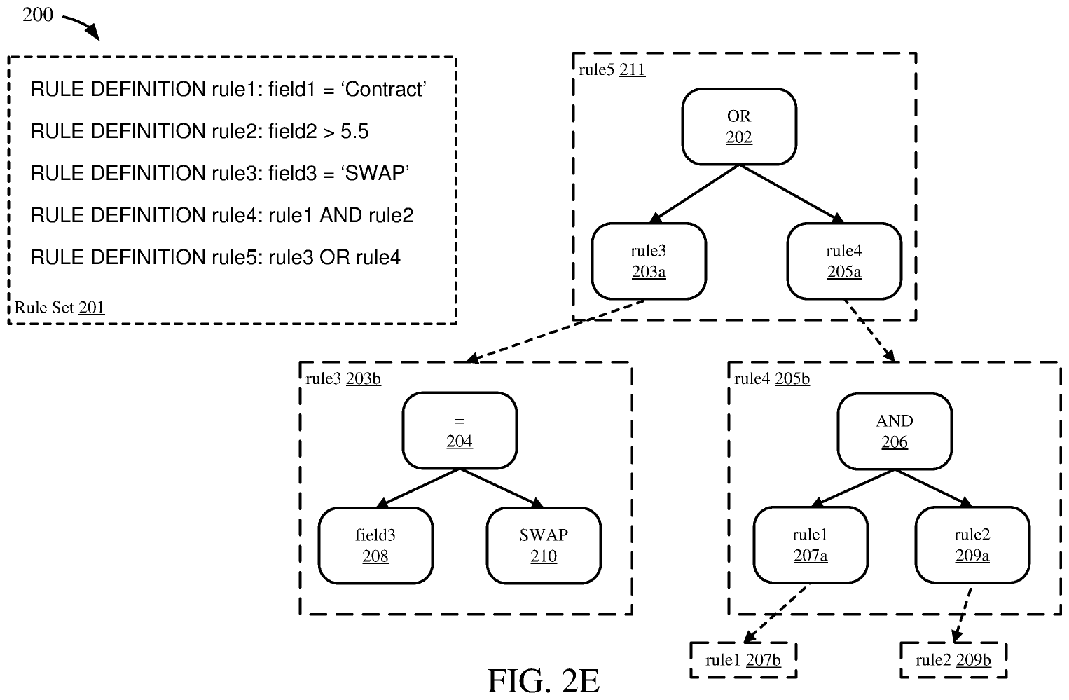

FIGS. 2A-E are an example 200 illustrating how a rule can be represented as a binary tree. The example 200 is based on a rule set 201 having rules rule1, rule2, rule3, rule4, and rule5. The example 200 illustrates generating a binary tree for rule5 through FIGS. 2A-D. Such binary trees can be graphs, or graph-theoretical trees (e.g. trees based on graph theory, or usable in graph theory).

Generally, the process to transform a rule into a tree is as follows. First, the operator in the rule is identified, or the highest-priority operator if there are multiple operators. The operator is placed in a node, while the left side of the operator (e.g. everything before the operator) forms one subtree from the operator node and the right side of the operator (e.g. everything after the operator) forms another subtree from the operator node. This is repeated for each subtree (e.g. the left side and the right side) until the nodes on each side are leaves, which have either fields or values (e.g. but not operators). This process may be done iteratively, or recursively.

In FIG. 2A, the operator for rule5, “OR,” is placed in a root node 202. The left leaf node from the OR node 202 is formed with the first operand rule3 into node 203a, while the right leaf node from the OR node 202 is formed with the second operand rule4 into node 205a. Because neither rule3 nor rule4 is a field or value, each can be transformed into a tree as well, as a subtree of the OR node 202. This transformation can be performed in a first iteration.

FIG. 2B illustrates a first half of a second iteration. Rule3 in the rule3 node 203a can be transformed similarly to rule5 show in FIG. 2A. The rule3 node 203a can be replaced with the rule3 operator “=” as node 204. Then, the left leaf can be formed with the field “field3” as the field3 node 208. The right leaf can be formed with the value “SWAP” as the SWAP node 210. Because the field3 node 208 and the SWAP node 210 both represent fields or values, each node is a leaf and there is no further transformation necessary.

Next, FIG. 2C illustrates a second half of the second iteration. Rule4 in the rule4 node 205a can be transformed similarly to rule5 show in FIG. 2A or rule3 shown in FIG. 2B. The rule4 node 205a can be replaced with the rule4 operator “AND” as node 206. Then, the left leaf can be formed with the operand “rule1” as the rule1 node 207a. The right leaf can be formed with the operand “rule2” as the rule2 node 209a. Because both the left 207a and right 209a nodes represent rules as operands, each can be further transformed.

FIG. 2D illustrates the third iteration, transforming both the left and right nodes of AND node 206. The rule1 node 207a can be transformed into a subtree based on rule1, with operator “=” in node 212 and the left node as field1 node 216 and the right node as Contract node 218. Both field1 node 216 and Contract node 218 are leaf nodes, representing fields or values, and so no further transformation at this part of the tree is needed. The rule2 node 209a can be transformed into a subtree based on rule2, with operator “>” in node 214 and the left node as field2 node 220 and the right node as 5.5 node 222. Both field2 node 220 and 5.5 node 222 are leaf nodes, having fields and values, and so no further transformation is needed.

Thus, in this way, a rule can be transformed into a binary tree, which can facilitate rule analysis and mining, as described herein. For example, representing rules as binary or graph-theoretical trees can facilitate usage of tree serialization and hashing algorithms, or other tree search algorithms, to find matching or duplicate trees or subtrees.

FIG. 2E illustrates an alternate or additional form of a binary tree for the example 200. In some cases, rule nodes (e.g. rule3 node 203a, rule4 node 205a, rule1 node 207a, and rule2 node 209a) may not be replaced with their subtrees. Instead, such rule nodes 203a, 205a, 207a, 209a can point to their respective tree representations of rules 203b, 205b, 207b, 209b, 211. For example, the rule3 node 203a can contain a reference to the tree representation of rule3 203b, which can be the subtree of nodes 204, 208, 210 as shown previously. Similarly, the rule4 node 205a can point to the rule4 tree 205b, the rule1 node 207a can point to the rule1 tree 207b, and the rule2 node 209a can point to the rule2 tree 209b. In this way, knowledge of the separate rules (e.g. rule1, rule2, rule3, rule4) which form the transformed rule (e.g. rule5) can be available in the tree. Such information can be stored in the rule nodes 203a, 205a, 207a, 209a, or be stored as separate metadata for the rules 201 or rule trees 203b, 205b, 207b, 209b, 211.

### EXAMPLE 5

### Example Method that Mines a Rule Set to Generate Logic Statement Proposals

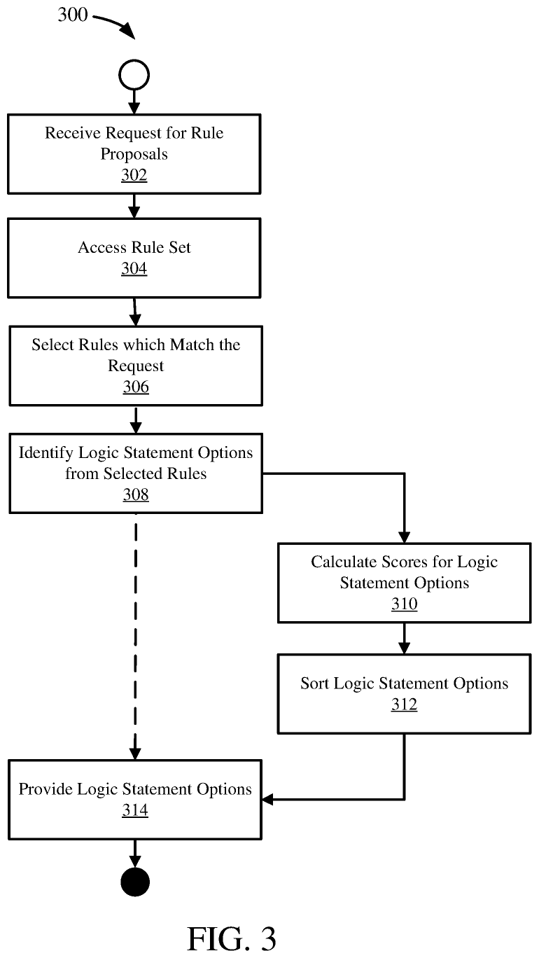

FIG. 3 is a flowchart of an example method 300 of mining a rule set to generate one or more logic statement proposals and can be implemented, for example, by the system described in FIG. 1.

At 302, a request for rule proposals can be received. A rule proposals request can include one or more variables or input arguments, such as described herein. For example, a rule proposal request can include a rule or an identifier for a rule (to which the rule proposals can be added to develop a more complex rule), a rule set or identifier for a rule set (which can include location or other access information for the rule set), or other settings for generating rule proposals.

At 304, a rule set can be accessed. The rule set accessed at 304 can be applicable or related to the rule included in the rule proposal request at 302. The rule set accessed can be the rule set received or otherwise identified at 302. In some cases, the rule set can be available in local memory. In other cases, the rule set can be available in a database or rule repository (e.g. a file), and accessing the rule set at 304 can include accessing the database or rule repository and obtaining the rule set.

In some embodiments, the rule set accessed at 304 can include rules already in a graph-theoretical form or binary tree, as described herein. In other embodiments, accessing the rule set at 304 can include transforming one or more of the rules in the rule set into a binary tree or other graph-theoretical form.

At 306, one or more rules can be selected or identified that match the input rule received at 302. Generally, a rule from the rule set can be selected based on a match between the input rule from 302 and at least a portion of the selected rule. A match can include matching a portion or subtree of a rule in the rule set. For example, an existing rule in the rule set can be considered a match to the input rule if at least a portion of the existing rule matches the input rule, such as when the input rule matches a subtree of the existing rule. Thus, a match can be between the input rule and a subtree of a rule in the rule set.

Further, a match can include logically equivalent rules or subtrees of rules, as well as exact matches. For example, a rule “field1==field2” is generally logically equivalent to a rule “field2==field1.” As another example, a rule “field1=5.5” can be considered to be logically equivalent to a rule “pointer1=5.5” if pointer1 is a pointer variable to field1.

Selecting matching rules at 306 can include executing an algorithm to identify matching, or duplicate, subtrees, such as tree serialization or hashing algorithms, complete search, or other tree search algorithms.

At 308, one or more logic statement options can be identified from the matching rules selected at 306. A logic statement option can be a subtree of a rule from the rule set (e.g. a portion of a rule from the rule set). Generally, identifying the logic statement options can include identifying subtrees of a rule selected at 306 that are logically related to the portion of the selected rule which matches the input rule. A subtree can be logically related to another subtree by being connected through a parent node one level above the subtrees. For example, as seen in FIG. 2C, rule1 207a is logically related to rule2 209a because they are connected by their parent node 206. Thus, from the example 200, if rule1 is an input rule, rule2 can be a logic statement option based on this logical relation. Generally, the identified logic statement options can include logically related subtrees from each of the selected rules which include a match to the input rule. Thus, multiple logic statement options can be obtained from multiple rules in the rule set.

In some embodiments, the logical relation can be through multiple hierarchical levels of a rule tree. For example, two parent nodes can be traversed to find a logically related rule (e.g. for example 200, rule1 207a can be logically related to rule3 through the parent AND node 206 and the parent OR node 202).

At 310, scores can be calculated for the logic statement options identified at 308. Calculating a score can include calculating a usage score or statistic for a logic statement option. For example, a usage score can be an indicator for how often the logic statement appears in the rule set, whether by itself or as a portion of other rules. Other data can be used as well to calculate such scores, such as metadata associated with the logic statement options.

At 312, the logic statement options can be sorted. The sorting can be based on the scores for each option. For example, the options can be sorted in descending order of their scores, with the most commonly used options first. Additionally or alternatively, sorting at 312 can include filtering the options. For example, options with a score that does not meet a threshold can be removed from the set of options. As another example, a set number of options can be retained, such as the top three options, and other options can be removed. In some embodiments, an option can be automatically selected, such as the option with the highest score.

In some cases, once the logic statement options are identified at 308, the process 300 can proceed to providing the logic statement options at 314, skipping score calculation at 310 and sorting at 312. Score calculation at 310 and sorting at 312 can be independently optional steps in such cases.

At 314, the logic statement options can be provided. Providing the logic statement options can include providing their respective scores as well. Additionally or alternatively, providing the logic statement options can include providing metadata associated with the logic statement options, or other information about the logic statement options. The logic statement options can be provided as additions to the input rule.

In some embodiments, the logic statement options can be provided as an ordered set, where the order indicates their relative strength or usage. The options can be provided at 314 through a user interface, which can allow for selection of an option to add or otherwise develop the input rule included in the request at 302. Alternatively or additionally, the logic statement options can be provided through an API, such as to another system, or through a messaging interface.

In some embodiments, after providing the logic statement proposals, a selection of one or more of the logic statement proposals can be received. The received selections can then be added to the input rule, such as by appending or otherwise connecting to the input rule (e.g. connecting as a subtree to the input rule displayed as a tree).

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### EXAMPLE 6

### Example Method that Mines a Rule Set to Deduplicate an Input Rule

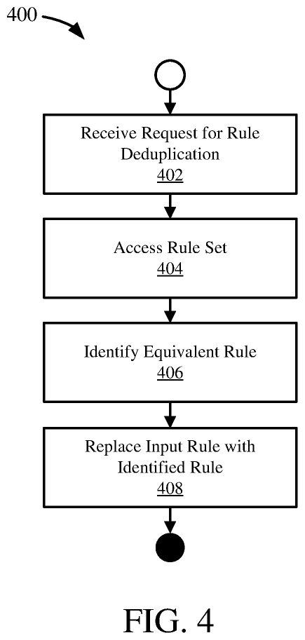

FIG. 4 is a flowchart of an example method 400 of mining a rule set to deduplicate an input rule and can be implemented, for example, by the system described in FIG. 1.

At 402, a request for rule deduplication can be received. The request at 402 can be similar to a rule proposal request received at 302 in process 300 shown in FIG. 3. A rule deduplication request can include one or more variables or input arguments, such as described herein. For example, a rule proposal request can include a rule or an identifier for a rule (which is to be deduplicated by process 400), a rule set or identifier for a rule set (which can include location or other access information for the rule set), or other settings for generating rule proposals.

At 404, a rule set can be accessed. Accessing the rule set at 404 can be similar to accessing a rule set at 304 in process 300 shown in FIG. 3. The rule set accessed at 404 can be applicable or related to the rule included in the rule deduplication request at 402. The rule set accessed can be the rule set received or otherwise identified at 402. In some cases, the rule set can be available in local memory. In other cases, the rule set can be available in a database or rule repository (e.g. a file), and accessing the rule set at 404 can include accessing the database or rule repository and obtaining the rule set.

In some embodiments, the rule set accessed at 404 can include rules already in a graph-theoretical form or binary tree, as described herein. In other embodiments, accessing the rule set at 404 can include transforming one or more of the rules in the rule set into a binary tree or other graph-theoretical form.

At 406, one or more rules can be identified that are equivalent to the input rule received at 402. Identifying equivalent rules at 406 can be similar to selecting rules which match the input request at 306 in process 300 shown in FIG. 3. Generally, a rule from the rule set can be identified based on a match between the input rule from 402 and a rule in the rule set.

A match can include logically equivalent rules, as well as exact matches. For example, a rule “field1==field2” is generally logically equivalent to a rule “field2==field1.” As another example, a rule “field1=5.5” can be considered to be logically equivalent to a rule “pointer1=5.5” if pointer1 is a pointer variable to field1.

Identifying equivalent rules at 406 can include executing an algorithm to identify matching, or duplicate, subtrees, such as tree serialization or hashing algorithms, complete search, or other tree search algorithms.

At 408, the input rule can be replaced with the identified equivalent rule from 406. Replacing the input rule can include changing an identifier for the input rule to the identifier for the equivalent rule. Other data associated with the equivalent rule, such as metadata as described herein, can be added to the input rule, or used to replace additional data associated with the input rule. In this way, the input rule can reuse the existing equivalent rule, and thus the rule set can store a single rule for given logic, rather than duplicating the same logic across multiple, stored rules.

In some cases, multiple equivalent rules can be identified at 406. In such cases, replacing the rule at 408 can include providing the identified equivalent rules (from 406) and receiving a selection of a particular equivalent rule with which to replace the input rule. Providing the equivalent rules can include displaying the equivalent rules as options in a user interface, for example. In some embodiments, an equivalent rule can be automatically selected if there are multiple equivalent rules, and used to replace the input rule (e.g. such as based on a usage score, which can be calculated for the equivalent rules, as similarly described for process 300).

### EXAMPLE 7

### Example Method that Mines a Rule Set to Generate a Rule Template

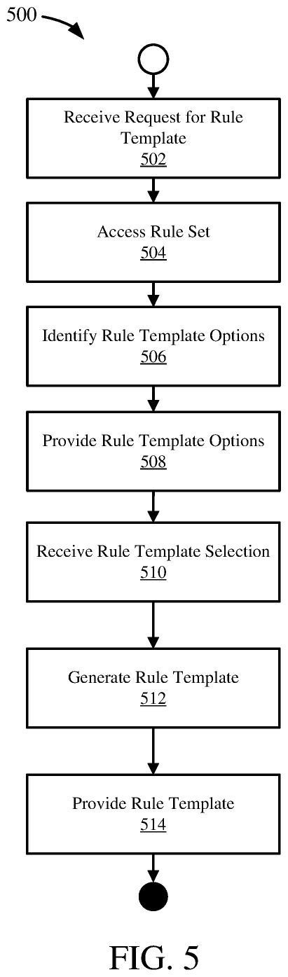

FIG. 5 is a flowchart of an example method 500 of mining a rule set to provide a rule template and can be implemented, for example, by the system described in FIG. 1.

At 502, a request for a rule template can be received. The request at 502 can be similar to a rule proposal request received at 302 in process 300 shown in FIG. 3 or a rule deduplication request received at 402 in process 400 shown in FIG. 4. A rule template request can include one or more variables or input arguments, such as described herein. For example, a rule template request can include a rule or an identifier for a rule (which can be used as a basis for generating a rule template), a rule set or identifier for a rule set (which can include location or other access information for the rule set), or other settings for generating rule templates.

At 504, a rule set can be accessed. Accessing the rule set at 504 can be similar to accessing a rule set at 304 in process 300 shown in FIG. 3 or at 404 in process 400 shown in FIG. 4. The rule set accessed at 504 can be applicable or related to the rule included in the rule template request at 502. The rule set accessed can be the rule set received or otherwise identified at 502. In some cases, the rule set can be available in local memory. In other cases, the rule set can be available in a database or rule repository (e.g. a file), and accessing the rule set at 504 can include accessing the database or rule repository and obtaining the rule set.

In some embodiments, the rule set accessed at 504 can include rules already in a graph-theoretical form or binary tree, as described herein. In other embodiments, accessing the rule set at 504 can include transforming one or more of the rules in the rule set into a binary tree or other graph-theoretical form.

At 506, one or more rule template options can be identified. Identifying rule template options at 506 can be similar to selecting rules which match the input request at 306 in process 300 shown in FIG. 3 or identifying equivalent rules at 406 in process 400 shown in FIG. 4. Generally, a rule template option can be an existing rule from the rule set. Generally, identifying rule template options can include identifying rules from the rule set based on a match between the input rule from 502 and at least a portion of the identified rule. A match can include matching a portion or subtree of a rule in the rule set. For example, an existing rule in the rule set can be considered a match to the input rule if at least a portion of the existing rule matches the input rule, such as when the input rule matches a subtree of the existing rule. Thus, a match can be between the input rule and a subtree of a rule in the rule set. Thus, a rule template option can be a rule from the rule set which matches, at least in part, the input rule.

Further, a match can include logically equivalent rules or subtrees of rules, as well as exact matches. For example, a rule “field1==field2” is generally logically equivalent to a rule “field2==field1.” As another example, a rule “field1=5.5” can be considered to be logically equivalent to a rule “pointer1=5.5” if pointer1 is a pointer variable to field1.

Identifying rule template options at 506 can include executing an algorithm to identify matching, or duplicate, subtrees, such as tree serialization or hashing algorithms, complete search, or other tree search algorithms.

At 508, the rule template options can be provided. Providing the rule template options at 508 can be similar to providing the logic statement options at 314 in process 300 shown in FIG. 3 or providing multiple equivalent rules in process 400 shown in FIG. 4. Providing the rule template options can include providing their respective metadata associated with the identified rules from 506, or other information about the identified rules. Additionally or alternatively, the complete rules (e.g. text of the rules) identified at 506 can be provided at 508. In some embodiments, the rule template options can be provided in a user interface, such as for review and selection by a user.

At 510, a rule template selection can be received. Receiving a rule template selection can include receiving an identifier for the rule of the rule template options to be used to generate a rule template.

At 512, a rule template can be generated based on the rule template selection received at 510. Generating a rule template can include retrieving the complete rule selected. Additionally or alternatively, generating a rule template can include generating a copy of the rule selected. In some cases, generating the rule template can include transforming a rule represented in a graph-theoretical form (e.g. a binary tree) into a text or other human-readable format. In other cases, the rule tree can be provided, formatted for display.

At 514, the generated rule template can be provided. Providing the generated rule template can be similar to providing the rule template options at 508.

### EXAMPLE 8

### Example Input Rule Development Request, Rule Set, and Rule Mining Results based on the Request and Rule Set

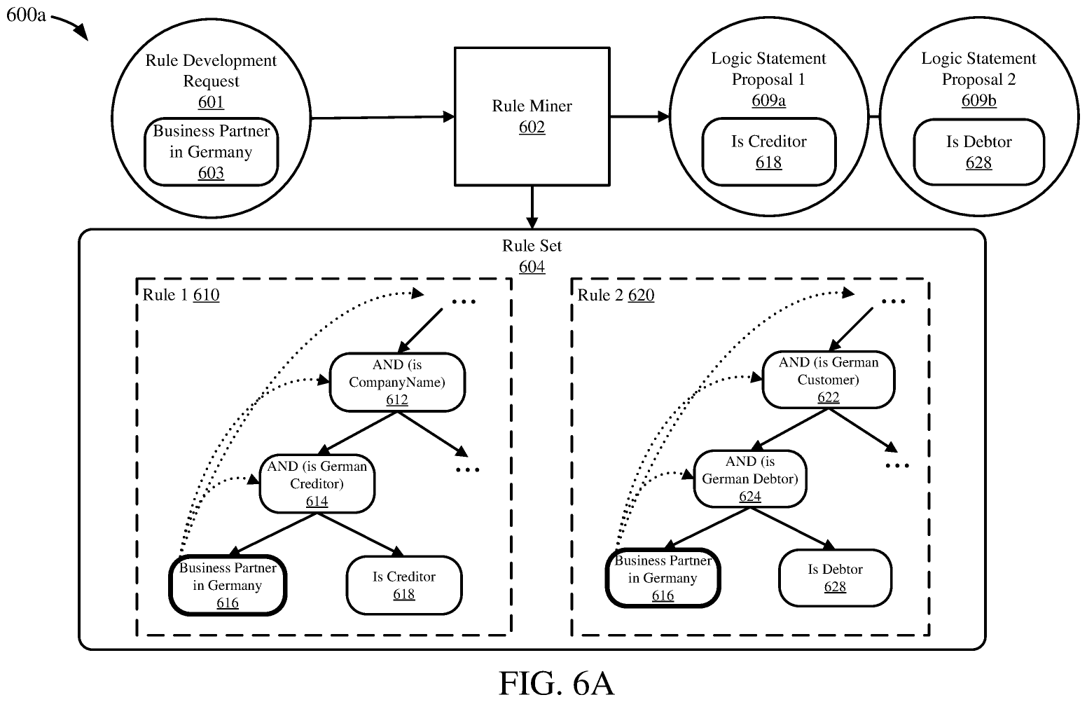

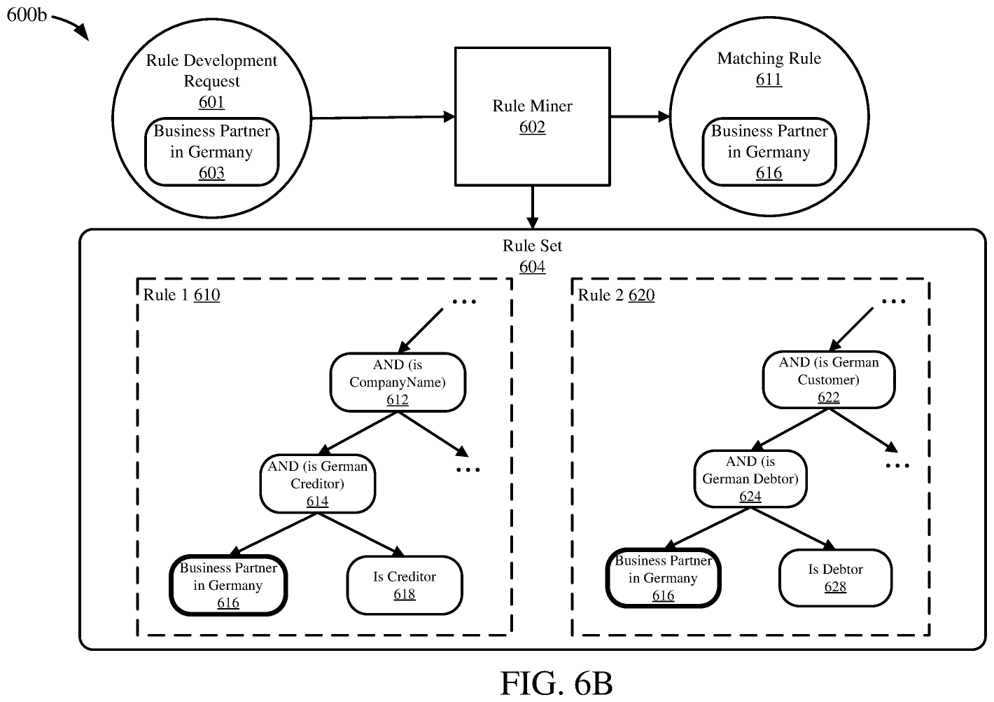

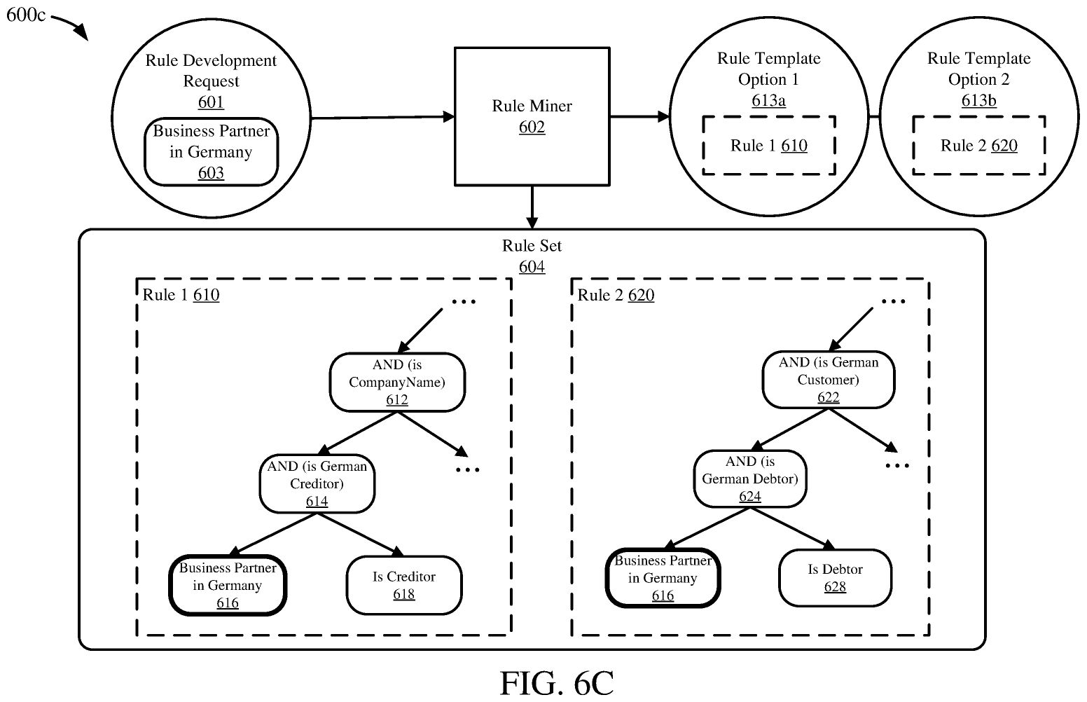

FIGS. 6A-C are an example 600a-c illustrating how a rule set can be mined to generate rule mining results based on a rule development request. A rule development request 601 can include a rule “Business Partner in Germany” 603, and can be received by a rule miner 602. The rule miner 602 can access a rule set 604 to mine the rules in the rule set to satisfy the rule development request 601. The rule set 604 can include at least two rules, Rule 1 610 and Rule 2 620. The rule set 604 can include other rules as well. Rule 1 610 can include multiple subtrees which can be logic statements or rules 612, 614, 616, 618. Rule 2 620 can likewise include multiple subtrees which can be logic statements or rules 622, 624, 616, 628.

Example 600a illustrates the rule miner 602 identifying and providing logic statement proposals 609a-b, such as via process 300 shown in FIG. 3. The rule miner 602 can analyze the rule set 604 and determine that the rule node “Business Partner in Germany” 616 is logically equivalent to the input rule “Business Partner in Germany” 603. Because the rule node “Business Partner in Germany” 616 is a node or subtree of rules 1 and 2 610, 620, both rules 1 and 2 are identified as applicable to the rule proposal request 601. The rule miner 602 can then discover logically related rules or logic statements to the matched rule, e.g. the rule node “Business Partner in Germany” 616, by traversing to the parent node of the matched rule. Thus, the rule miner 602 can find from rule 1 610 the rule “Is Creditor” node 618 as a logically related subtree of the parent node “AND (is German Creditor)” node 614. Similarly, the rule miner 602 can find from rule 2 620 the rule “Is Debtor” node 628 as a logically related subtree of the parent node “AND (Is German Debtor)” node 624. The rule miner 602 can then provide these rules or logic statements 618, 628 as logic statement proposals 1 and 2 609a-b, such as for use in further developing the input rule 603.

In some embodiments, the rule miner 602 can analyze higher levels of parent nodes than the immediate parent node. For example, in rule 1 610, the rule miner 602 can additionally or alternatively provide a logic statement (e.g. “is CompanyName”) based on the second level parent node “AND (is CompanyName).” Other, higher levels of traversal can also be used to identify logic statements logically related to the input rule 603.

Example 600b illustrates the rule miner 602 deduplicating a rule 603, such as via process 400 shown in FIG. 4. Similar to scenario 600a, the rule miner 602 can analyze the rule set 604 and determine that the rule node “Business Partner in Germany” 616 is logically equivalent to the input rule “Business Partner in Germany” 603. Accordingly, the rule miner 602 can provide the rule “Business Partner in Germany” 616 as the matching rule 611, which can be used to replace the input rule 603. In this way, rules in development can be deduplicated, to avoid repetition in storage and to more accurately track rule usage.

Example 600c illustrates the rule miner 602 identifying and providing rule template options 613a-b, such as via process 500 shown in FIG. 5. Similar to scenario 600a and scenario 600b, the rule miner 602 can analyze the rule set 604 and determine that the rule node “Business Partner in Germany” 616 is logically equivalent to the input rule “Business Partner in Germany” 603.

### EXAMPLE 9

### Example User Interface for Rule Development Using Rule Mining

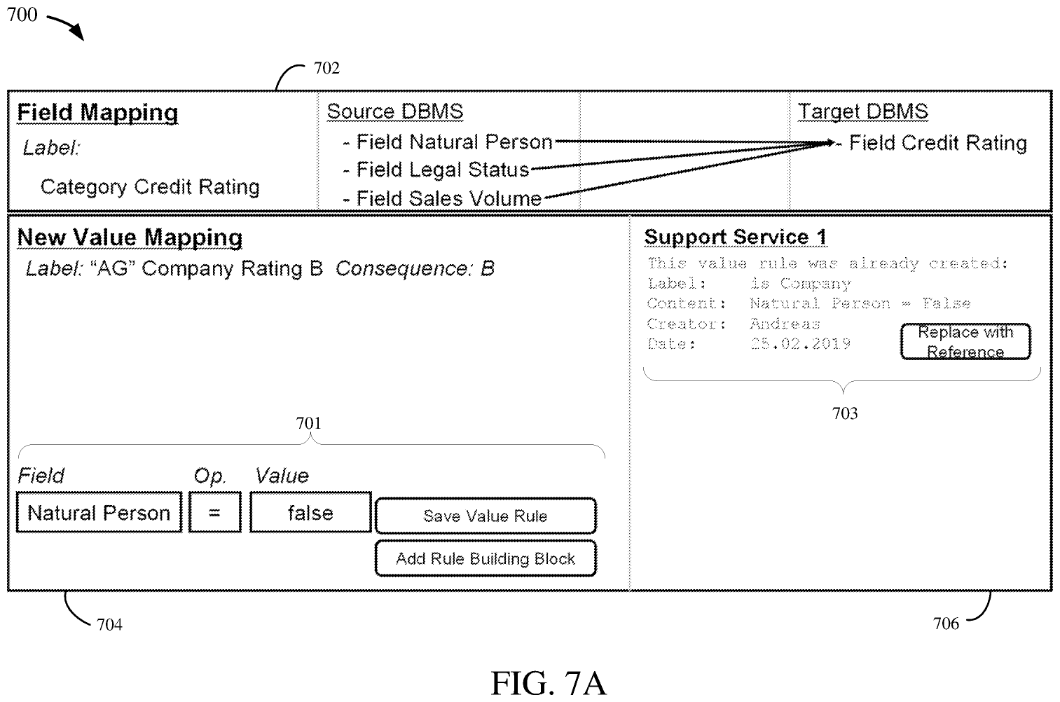

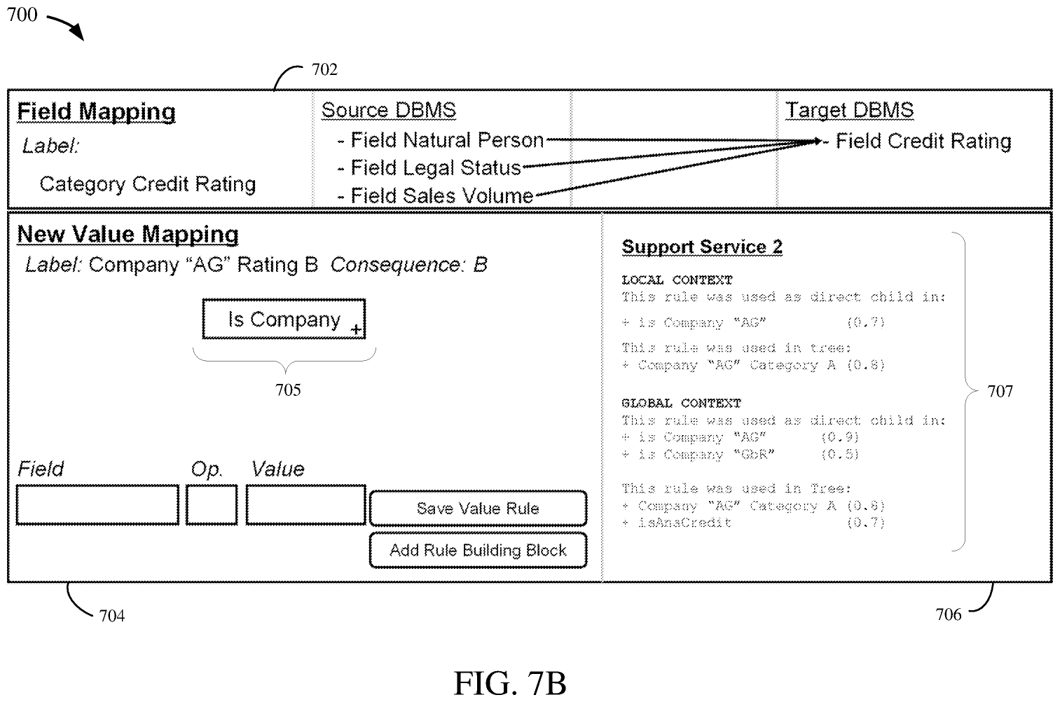

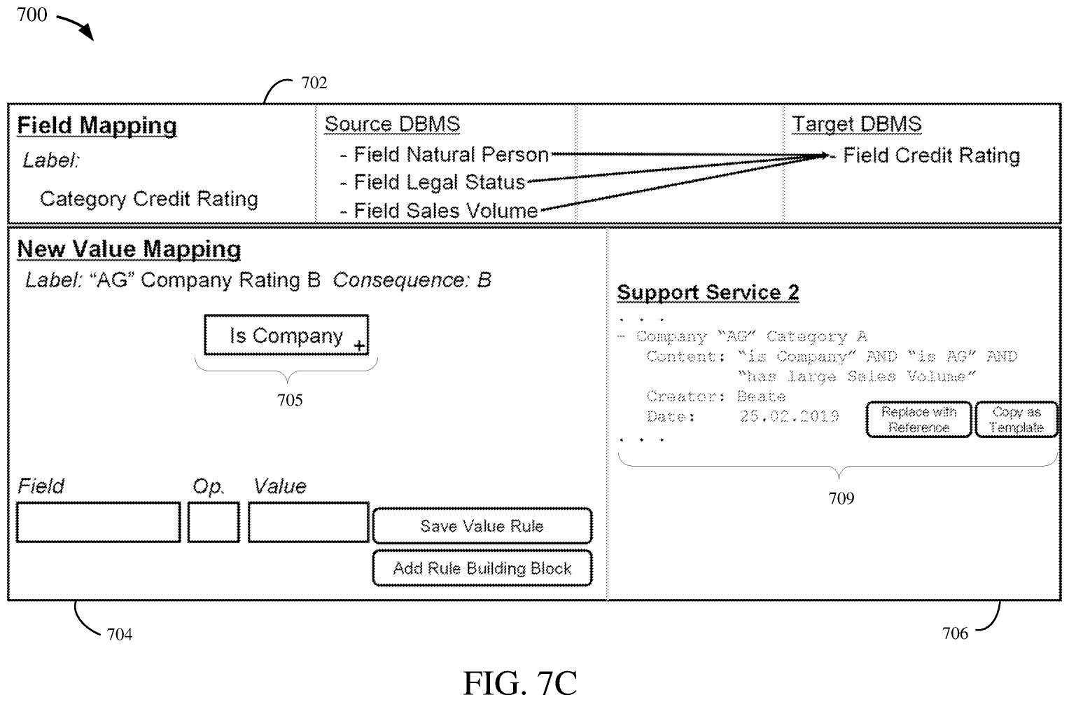

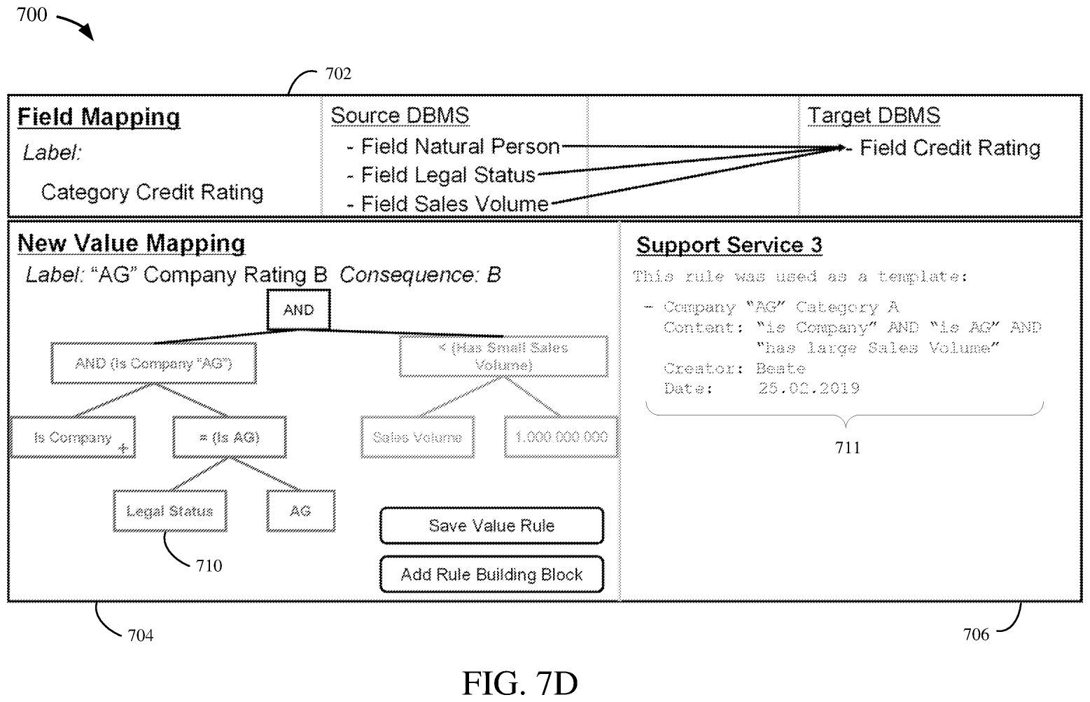

FIGS. 7A-D are an example 700 illustrating a rule development workflow in a user interface for rule development utilizing rule mining functionality, as described herein. The user interface can have several sections, such as a mapping section 702 indicating a current mapping between databases or data models, a rule development section 704 for developing new rules or viewing existing rules, and a smart support section 706 for providing rule mining results to assist in rule development.

As shown in FIG. 7A, a user can enter a logic statement 701 as a new rule, or the start of a new rule. Beginning a new rule can trigger rule mining functionality, as described herein, such as rule deduplication. A match for the new rule 701 can be returned, and data (e.g. metadata) for the existing rule can be displayed 703. A button can be provided at 703, along with the matching rule data, to replace the new rule with the existing rule (e.g. to deduplicate the new rule). In other embodiments, the new rule can be automatically replaced by the existing rule.

As shown in FIG. 7B, the new rule 701 can be replaced, either automatically or by user selection, with the existing rule 703, and thus shown as the rule currently in development 705. Rule mining to obtain logic statement proposals can then be triggered, such as automatically when the rule 705 is accepted or manually such as by a button. The logic statement proposals from the triggered rule mining can be displayed 707, along with additional data (e.g. metadata) and usage scores. The display of the rule proposals 707 can hide some data, which can be made visible by the “+” icon.

FIG. 7C illustrates an expanded rule proposal 709, which can provide functionality for adding the rule proposal to the current rule under development 705 or functionality for using the proposed rule as a template for the rule under development, as well as additional data about the proposed rule.

FIG. 7D illustrates the results of a user selecting the proposed rule 709 to use as a template. Thus, the rule 705 has been replaced with a rule template (e.g. a rule tree) 710 based on the selected proposed rule template. The user can then edit the rule template 710 before saving as a new rule. Nodes which have not been changed can be saved as references to their existing counterparts, rather than saved anew. Metadata 711 for the rule template 710 can be displayed as well, and can indicate the rule was generated as a template from another rule.

### EXAMPLE 10

### Example Rules, Logic Statements, and Rule Building Blocks

In any of the examples herein, a rule can be a first order logic statement which evaluates to true or false. A rule can be composed of multiple smaller rules or logic statements. A rule can further be composed of one or more rule building blocks.

A rule building block can include two operands and an operator. The operands can be a field or variable, or a value. In some cases, an operand can be another rule or rule building block. For example, a rule building block can be composed of a field, an operator, and a value, such as in a logic statement “field1=4.” Thus, a rule can be composed of a single rule building block, or multiple rule building blocks. A rule building block can be a rule, as described herein. As an example, a node in a rule tree as described herein, can be a rule building block.

Rules can be used to determine a process flow or a work flow. Additionally, rules can be used to identify instance data from a data set, such as records in a database. Such identification can be used to sort, map, transform, process or otherwise manipulate particular sets of records. Thus, instance data, such as database records, can be processed or manipulated using rules. Thus, rules can be used to transform data records from one database/data model to another database/data model.

Rules, logic statements, and rule building blocks can be stored in a rule framework. A rule framework can be accessible by a rule miner, as described herein, for rule mining.

### EXAMPLE 11

### Example Rule Set and Mapping

In any of the examples herein, a rule set can be a group or collection of rules, such as may be stored in a database or other rule framework.

In any of the examples herein, a mapping can be a rule set including rules for transforming data from a first database/data model to a second database/data model. Mappings can cover larger sets of instance data, or additional processing flows. Mappings can also integrate different sets or subsets of data or functionality.

### EXAMPLE 12

### Example Rule Metadata

In any of the examples herein, rule metadata can include information about a given rule, logic statement, or rule building block. Rule metadata can include human-readable information or other semantic notation, which can simplify or more readily describe complex rules. For example, rule metadata can include a label or name for the rule, an identifier for the rule, a data/time created, a creator name or identifier, or usage information (e.g. number of other rules in which the rule is used). Rule metadata can be stored in association with its rule, such as in a rule framework, and can be accessible along with the rule or through the rule (e.g. via the rule identifier).

### EXAMPLE 13

### Example Rule Mining Types

In any of the examples herein, rule mining can be of a particular type, which can define the rule mining functionality and results. Rule mining types can include rule deduplication (see FIG. 4), rule or logic statement proposals (see FIG. 3), or rule template generation (see FIG. 5).

Rule mining generally includes finding one or more rules which match (e.g. are logically equivalent to) an input rule, in whole or in part. Once a match is found, the rule mining type can indicate how to process the matches and what to return.

Rule deduplication can return the rule or rule building block that is matched. Generally, this is a complete match and does not return a rule of which the input rule is only a part.

Rule proposals analyze the matched rules to identify logically related rules (e.g. rule building blocks) within the matched rules, and then return the logically related rules. In this way, rule proposal rule mining builds on the rule deduplication rule mining.

Rule template generation returns the complete matched rules for use as a template. In this way, the rule template generation builds on the rule deduplication and the rule proposal mining.

### EXAMPLE 14

### Example Rule Mining Triggers for Automatic Rule Mining

In any of the examples herein, a rule mining trigger can indicate or initiate execution of rule mining functionality, as described herein. A rule mining trigger generally initiates automatic rule mining based on the trigger. For example, entering a new complete rule (e.g. at least a rule building block or complete logic statement) for development can trigger rule mining. As another example, changing focus from a node in a rule tree can trigger rule mining.

### EXAMPLE 15

### Example Rule Mining Scores and Score Calculation

In any of the examples herein, rule mining can include generating a ranking score for the results. A ranking score for a rule can be a usage score or a coverage score, or a combination of both. Generally, the scores can be calculated based on the rule set being mined.

A usage score for a rule can be a measure of the number of uses (e.g. value mappings, or times the rule is used within a mapping) that reference the rule. The usage score can be calculated as the number of uses divided by the maximum use in the system; this calculation can normalize the score to a given range, such as from 0 to 1, for easier use (with higher numbers representing more usage).

A coverage score for a rule can be a measure of the extent of the rule within a rule tree. The coverage score can be calculated as the number of nodes in the identified rule divided by the total number of nodes within the rule of which the identified rule is a part. The coverage score is also normalized, with a score range of 0 to 1 for easier use (with higher numbers representing more coverage by the identified rule).

A combined score for an identified rule (e.g. rule proposal) can be calculated as two times the usage score times the coverage score, all divided by the usage score plus the coverage score. The following are example formulae for calculating a ranking score for a proposal, R(P), a usage score of the proposal, and a coverage score of the proposal:

$$\begin{matrix}R ( P ) = \frac{2 * USAGE SCORE * COVERAGE SCORE}{USAGE SCORE + COVERAGE SCORE} & ( equation 1 ) \\ USAGE SCORE ( P ) = \frac{USAGE COUNT ( P )}{MAX USAGE} & ( equation 2 ) \\ COVERAGE SCORE ( P ) = \frac{NODE COUNT CURRENT TREE ( P )}{NODE COUNT PARENT TREE} & ( equation 3 )\end{matrix}$$

This equation has the property that if one score is zero, then the combined score is zero. Further, the equation penalizes smaller scores, which can be advantageous to sift similar rules more effectively. Calculating these ranking scores can further include additional heuristic calculations, such as based on additional metadata for the rules.

In some embodiments, calculating a ranking score can include filtering the rule set before calculating the score. For example, rule trees which have components (e.g. rule building blocks) not defined within the current mapping can be excluded or filtered. Alternatively, components in rule trees not in the current mapping can be added to the mapping.

In some embodiments, a marker or other indicator can be used, in addition to a ranking score, if the identified rule (for which the ranking score is calculated) is used in another portion of the rule currently in development, as this can indicate that the rule tree is derived from the same context.

### EXAMPLE 16

### Example Rule Deduplication for Rule Proposals and Rule Templates

In any of the examples herein, a rule proposal or a rule template can be automatically deduplicated when stored or added to a rule in development, as described herein. For example, when a rule proposal is added to a rule in development, a reference to the existing rule (e.g. rule building block) can be added, rather than a copy of the proposed rule. In this way, rules can be automatically deduplicated during development when known existing rules are incorporated into a rule in development.

For rule templates, when a new rule based on a rule template is stored, it can be automatically deduplicated as well. For example, unchanged portions of a rule template (e.g. unchanged rule building blocks) can be converted to references to the original source rule, while new or changed portions of the rule template can be stored as new rules (e.g. rule building blocks). In some embodiments, the rule template can include the references to the original rules or rule building blocks when generated, which can be updated or removed as the rule template is changed.

Further, in some embodiments, automatic rule deduplication, as described herein, can be performed on new rules as part of the storing process.

### EXAMPLE 17

### Rule Miner Module Environments

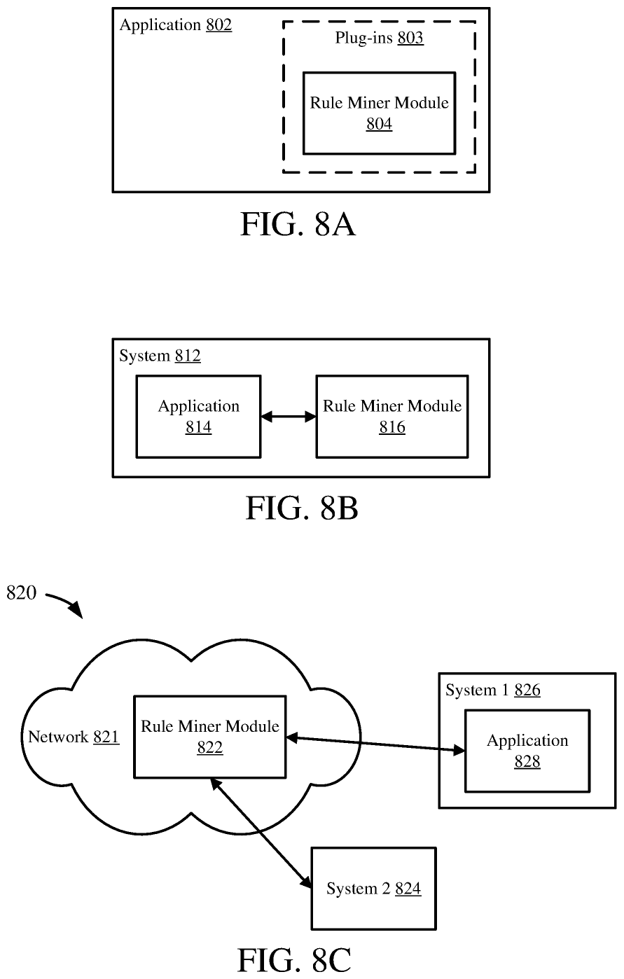

FIG. 8A is a schematic diagram depicting an application environment for a rule miner module 804, which may provide logic statement proposal, logic statement deduplication, or logic statement template functionality, or other rule mining functionality, as described herein. An application 802, such as a software application running in a computing environment, may have one or more plug-ins 803 (or add-ins or other software extensions to programs) that add functionality to, or otherwise enhance, the application. The rule miner module 804 may be integrated with the application 802; for example, the rule miner module may be integrated as a plug-in. The rule miner module 804 may add functionality to the application 802 for logic statement proposal, logic statement deduplication, or logic statement template, or other rule mining functionality, which may be displayed in a user interface or otherwise provided to a user. For example, the application 802 may be a database or data modeling application, or a database management application, and the rule miner module 804 may be integrated with the database or data management application to provide logic statement proposal, logic statement deduplication, or logic statement template functionality.

FIG. 8B is a schematic diagram depicting a system environment for a rule miner module 816, which may provide logic statement proposal, logic statement deduplication, or logic statement template functionality, or other rule mining functionality, as described herein. The rule miner module 816 may be integrated with a computer system 812. The computer system 812 may include an operating system, or otherwise be a software platform, and the rule miner module 816 may be an application or service running in the operating system or platform, or the rule miner module may be integrated within the operating system or platform as a service or functionality provided through the operating system or platform. The system 812 may be a server or other networked computer or file system. Additionally or alternatively, the rule miner module 816 may communicate with and provide logic statement proposal, logic statement deduplication, or logic statement template functionality, or other rule mining functionality as described herein, to one or more applications 814, such as a database, data modeling, or database management applications, in the system 812.

FIG. 8C is a schematic diagram depicting a network environment 820 for a rule miner module 822, which may provide logic statement proposal, logic statement deduplication, or logic statement template functionality, or other rule mining functionality, as described herein. The rule miner module 822 may be available on a network 821, or integrated with a system (such as from FIG. 8B) on a network. Such a network 821 may be a cloud network or a local network. The rule miner module 822 may be available as a service to other systems on the network 821 or that have access to the network (e.g., may be on-demand software or SaaS). For example, system 2 824 may be part of, or have access to, the network 821, and so can utilize logic statement proposal, logic statement deduplication, or logic statement template functionality from the rule miner module 822. Additionally, system 1 826, which may be part of or have access to the network 821, may have one or more applications, such as application 828, that may utilize logic statement proposal, logic statement deduplication, or logic statement template functionality, or other rule mining functionality, from the rule miner module 822.

In these ways, the rule miner module 804, 816, 822 may be integrated into an application, a system, or a network, to provide logic statement proposal, logic statement deduplication, or logic statement template functionality, or other rule mining functionality, as described herein.

### EXAMPLE 18

### Computing Systems

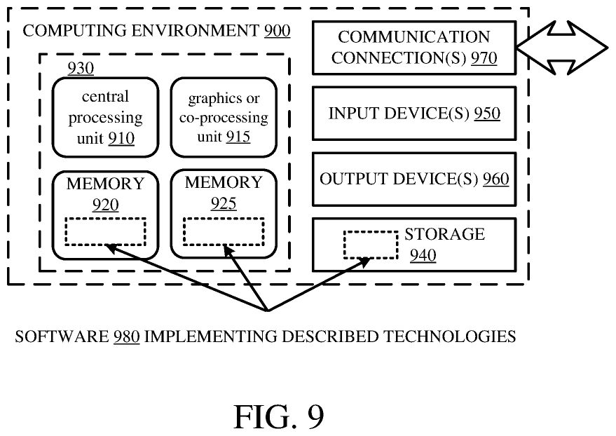

FIG. 9 depicts a generalized example of a suitable computing system 900 in which the described innovations may be implemented. The computing system 900 is not intended to suggest any limitation as to scope of use or functionality of the present disclosure, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing components of the processes of FIGS. 3, 5, and 6, the systems of FIGS. 1 and 8A-C, or the data, data representations, or data structures of FIGS. 2A-E and 4, and the displays and examples of FIGS. 2A-E and 7A-D. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915. The memory 920, 925, may also store settings or settings characteristics, databases, data sets, rule sets, interfaces, displays, or examples shown in FIGS. 2A-E, 4, and 7A-D, the systems shown in FIGS. 1 and 8A-C, or the steps of the processes shown in FIGS. 3, 5, and 6.

A computing system 900 may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general purpose program, such as one or more lines of code in a larger or general purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### EXAMPLE 19

### Cloud Computing Environment

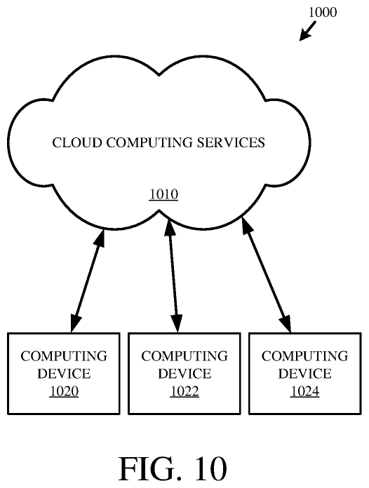

FIG. 10 depicts an example cloud computing environment 1000 in which the described technologies can be implemented. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, and the like).

### EXAMPLE 20

### Implementations

Although the operations of some of the disclosed methods are described in a particular, sequential order for convenient presentation, it should be understood that this manner of description encompasses rearrangement, unless a particular ordering is required by specific language set forth. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 9, computer-readable storage media include memory 920 and 925, and storage 940. The term computer-readable storage media does not include signals and carrier waves. In addition, the term computer-readable storage media does not include communication connections (e.g., 970).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

### EXAMPLE 21

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, implemented by one or more computing devices comprising at least one hardware processor and one or more tangible memories coupled to the at least one hardware processor, comprising:
receiving an input logic statement tree;
selecting a stored logic statement tree from a logic statement repository, wherein the input logic statement tree matches at least a portion of the stored logic statement tree;
identifying one or more logic statement subtrees within the stored logic statement tree, wherein the one or more logic statement subtrees are logically related to the portion of the stored logic statement tree that matches the input logic statement tree; and
providing the one or more logic statement subtrees, wherein the respective one or more logic statement subtrees represent complete logic statements.

2. The method of claim 1, further comprising:
receiving a selection of a logic statement subtree from the provided one or more logic statement subtrees; and
combining the selected logic statement subtree and the input logic statement tree.

3. The method of claim 1, further comprising:
calculating one or more scores for the respective one or more logic statement subtrees; and
wherein providing comprises providing the one or more scores with their respective logic statement subtrees.

4. The method of claim 3, further comprising:
ranking the one or more identified logic statement subtrees based on their respective scores; and
wherein the one or more logic statement subtrees are provided in ranked order.

5. The method of claim 3, wherein the scores are based on usage of the respective one or more logic statement subtrees.

6. The method of claim 3, wherein the scores are based on coverage of the respective one or more logic statement subtrees.

7. The method of claim 3, wherein the scores are based on a combination of usage and coverage of the respective one or more logic statement subtrees.

8. The method of claim 1, wherein providing comprises displaying the one or more logic statement subtrees.

9. The method of claim 8, wherein displaying comprises displaying one or more scores associated with the respective one or more logic statement subtrees.

10. The method of claim 8, wherein displaying comprises displaying metadata associated with the respective one or more logic statement subtrees.

11. One or more non-transitory computer-readable storage media storing computer-executable instructions for causing a computing system to perform a method, the method comprising:
receiving an input logic statement tree;
identifying a stored logic statement tree from the logic statement repository, wherein the stored logic statement tree is logically equivalent to the input logic statement tree; and
replacing the input logic statement tree with a reference to the identified stored logic statement tree.

12. The one or more non-transitory computer-readable storage media of claim 11, the method further comprising:
providing the identified stored logic statement tree;
receiving an indicator to use the provided logic statement tree; and
replacing the input logic statement tree in response to the received indicator.

13. The one or more non-transitory computer-readable storage media of claim 11,
providing the identified stored logic statement tree;
receiving an indicator to reject the provided logic statement tree; and
storing the input logic statement tree as a new logic statement instead of replacing the input logic statement tree.

14. The one or more non-transitory computer-readable storage media of claim 12, wherein a plurality of stored logic statement trees are identified that are logically equivalent to the input logic statement tree, the plurality is provided, and the received indicator provides an identifier for a selected provided logic statement tree.

15. The one or more non-transitory computer-readable storage media of claim 12, wherein providing includes providing metadata and/or a score for the identified logic statement tree.

16. A system comprising:
one or more memories;
one or more processing units coupled to the one or more memories; and
one or more computer-readable storage media storing instructions that, when loaded into the one or more memories, cause the one or more processing units to perform operations comprising:
receiving at least a portion of an initial logic statement tree;
identifying one or more stored logic statement trees from a logic statement repository, wherein the stored logic statement trees match the at least a portion of the initial logic statement tree;
providing the identified one or more stored logic statement trees;
receiving a selection of a logic statement tree of the one or more identified logic statement trees;
generating a logic statement template based on the selected logic statement tree, wherein the logic statement template comprises one or more subtrees; and
providing the generated logic statement template.

17. The system of claim 16, the operations further comprising:
receiving an updated logic statement tree, wherein the updated logic statement tree comprises the provided logic statement template and at least one change to the logic statement template; and
storing a new logic statement in a repository based on the updated logic statement tree.

18. The system of claim 16, the operations further comprising:
identifying one or more unchanged subtrees in the updated logic statement template; and
wherein storing the new logic statement in the repository comprises storing references to the original subtrees from the selected logic statement in place of the identified one or more unchanged subtrees in the updated logic statement.

19. The system of claim 16, the operations further comprising:
calculating one or more scores for the respective one or more identified stored logic statement trees; and
wherein providing the identified stored logic statement trees comprises providing the one or more scores with their respective stored logic statement trees.

20. The system of claim 19, wherein the one or more scores are based on usage of the respective stored logic statement trees, coverage of the respective stored logic statement trees, or a combination of usage and coverage.
